(19) United States
(12) Patent Application Publication
(10) Pub. No.: US 2009/0196143 A1
(43) Pub. Date: Aug. 6, 2009

(54) Method and System for Command-Ordering for a Disk-to-Disk-to-Holographic Data Storage System

(76) Inventors: Nils Haustein, Soergenloch (DE); Craig A. Klein, Tucson, AZ (US); Ulf Troppens, Mainz (DE); Daniel J. Winarski, Tucson, AZ (US)

Correspondence Address: DILLON & YUDELL, LLP, 8911 N CAPITAL OF TEXAS HWY, SUITE 2110, AUSTIN, TX, 78759, US

(21) Appl. No.: 12/026,986

(22) Filed: Feb. 6, 2008

(51) Int. Cl. G11B 7/00

(52) U.S. Cl. 369/103

(57) ABSTRACT

A system, method and computer program product for managing command ordering for a host-Disk-to-intermediate-Disk-to-Holographic (D2D2H) data storage system. Specifically, a command ordering detects a command from a host system. A hologram segment associated with the detected command is identified and a determination is made whether the hologram segment is an open hologram segment or a closed hologram segment. A determination is made whether the detected command is to be prioritized. If the detected command is prioritized, the detected command is added to a prioritized command queue. Moreover, if the detected command is not prioritized, the detected command is added to a normal command queue. The detected commands addressing the same hologram segment are then grouped. The execution of one or more grouped commands (prioritized or normal) is deferred for a predetermined period to allow for additional commands to be received for a same command group.

### BACKGROUND OF THE INVENTION

1. Technical Field

The present invention generally relates to a data processing system and in particular to a system for managing command-ordering for a host-Disk-to-intermediate-Disk-to-Holographic (D2D2H) data storage system.

2. Description of the Related Art

Existing host-Disk-to-intermediate-Disk-to-Holographic (D2D2H) data storage systems can have multiple host systems interfacing with a holographic storage system. Each host disk may try to either: (i) read data from or (ii) write data to hologram segments of a holographic storage system. In this regard, there can be multiple host disks that reference data to be read from or written to the same hologram segment or to different hologram segments.

However, there are several problems with the current D2D2H architecture. One problem arises when there are multiple host systems of different business importance/priority accessing (i.e., reading from and/or writing to) the same hologram segment. Sometimes, a host system of greater business importance/priority may be unsuccessful in timely completing the read or write command because the operation was executed subsequent to another command from a host system of lesser business importance/priority. This problem is exacerbated if the host systems are attempting to access a closed hologram segment (i.e., a hologram segment that resides in holographic media) that is stored in a tertiary storage holographic device.

Tertiary holographic storage or tertiary holographic memory is a holographic memory storage system, whereby a robotic arm will mount (insert) and dismount (remove) a removable holographic media cartridge to/from a holographic device according to the system's demands. Tertiary holographic storage can be used for archiving rarely accessed information, since the time to access tertiary holographic storage is longer than that of secondary storage. Tertiary holographic storage is especially useful for extraordinarily large data stores which are accessed without human operators.

However, the mechanism by which such type of tertiary holographic storage is accessed is a time consuming process. For example, when a host system reads information stored in tertiary holographic storage, the host system will typically consult a catalog database to determine which holographic media cartridge contains the hologram segment, which in turn, contains the information in question. Next, the host system will instruct a robotic arm to fetch the holographic media cartridge and insert the holographic media cartridge in the holographic drive. A read command is then sent by the host system to the holographic drive, said command is then applied to the holographic media cartridge containing the holographic media in question. When the host system has finished reading the information, the host will then instruct the robotic arm to return the holographic media cartridge to its place in the library immediately, or when access to another holographic media cartridge is requested.

In the case of a host system requesting a write command, the requested information that is stored in the closed hologram segment must then be emulated onto an intermediate disk as an open hologram segment in order to be written to by the host system. In addition to the time resources that are consumed in accessing (i.e., reading from or writing to) hologram segments in holographic media, there are typically a limited number of holographic drives to process all read/write (R/W) requests by the various host systems.

Another problem arises in D2D2H systems when multiple competing host systems try to access the same hologram segment simultaneously, but with conflicting commands. One example of a conflicting commands scenario is when a first host system wants to read data, while a second host system wants to simultaneously write data to the same hologram segment. Such a scenario can jeopardize data integrity.

### SUMMARY OF AN EMBODIMENT

Disclosed is a system, method and computer program product for command-ordering for a host-Disk-to-intermediate-Disk-to-Holographic (D2D2H) data storage system. Specifically, a command ordering utility detects a command from a host system. The command is either a read command or a write command. A hologram segment associated with the detected command is then identified. A determination is made whether the hologram segment is an open hologram segment or a closed hologram segment. If the hologram segment associated with the detected command is a closed hologram segment, a determination is then made whether to prioritize the detected command. If the detected command is to be prioritized, the detected command is added to a prioritized command queue. However, if the detected command is not to be prioritized, the detected command is added to a normal command queue. A plurality of detected commands addressing the same hologram segment is then grouped. The commands addressing the same hologram segment are from at least one of the prioritized command queue and the normal command queue. Once the detected command (i.e., prioritized command or normal command) has been added to the detected command's respective command queue (i.e., prioritized command queue or normal command queue), the execution of the detected command is deferred for a predetermined period of time to account for the grouping of commands that pertain to the same hologram segment. After the predetermined period of deferral has elapsed, the detected command is then executed in sequence.

The above as well as additional objectives, features, and advantages of the present invention will become apparent in the following detailed written description.

### BRIEF DESCRIPTION OF THE DRAWINGS

The invention itself will best be understood by reference to the following detailed description of an illustrative embodiment when read in conjunction with the accompanying drawings, wherein:

FIG. 1 is a block diagram of a data processing system within which the features of an illustrative embodiment may be advantageously implemented;

FIG. 2 is block diagram of a host-Disk-to-intermediate-Disk-to-Holographic (D2D2H) data storage system that is useful for understanding the invention;

FIG. 3 is a flowchart of exemplary method steps for command ordering in a D2D2H data storage system, according to an illustrative embodiment;

FIG. 4 is a flowchart of exemplary method steps for promoting normal commands in a D2D2H data storage system, according to an illustrative embodiment; and

FIG. 5 is a flowchart of exemplary method steps for the execution of commands within a D2D2H data storage system, according to an illustrative embodiment.

### DETAILED DESCRIPTION OF AN ILLUSTRATIVE EMBODIMENT

Disclosed is a system, method and computer program product for command-ordering for a host-Disk-to-intermediate-Disk-to-Holographic (D2D2H) data storage system. Specifically, a command ordering utility detects a command from a host system. The command is one of a read command and a write command. A hologram segment associated with the detected command is then identified. A determination is made whether the hologram segment is one of an open hologram segment and a closed hologram segment. If the hologram segment associated with the detected command is a closed hologram segment, a determination is then made whether to prioritize the detected command. If the detected command is to be prioritized, the detected command is added to a prioritized command queue. However, if the detected command is not to be prioritized, the detected command is added to a normal command queue. Once the detected command (i.e., prioritized command or normal command) has been added to the detected command's respective command queue (i.e., prioritized command queue or normal command queue), the execution of the detected command is deferred for a predetermined period of time to allow all detected commands that are associated with the same hologram segment to be grouped. After the predetermined period has elapsed, the detected command is then executed.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

It is also understood that the use of specific parameter names are for example only and not meant to imply any limitations on the invention. The invention may thus be implemented with different nomenclature/terminology utilized to describe all parameters and/or associated features that are provided herein, without limitation.

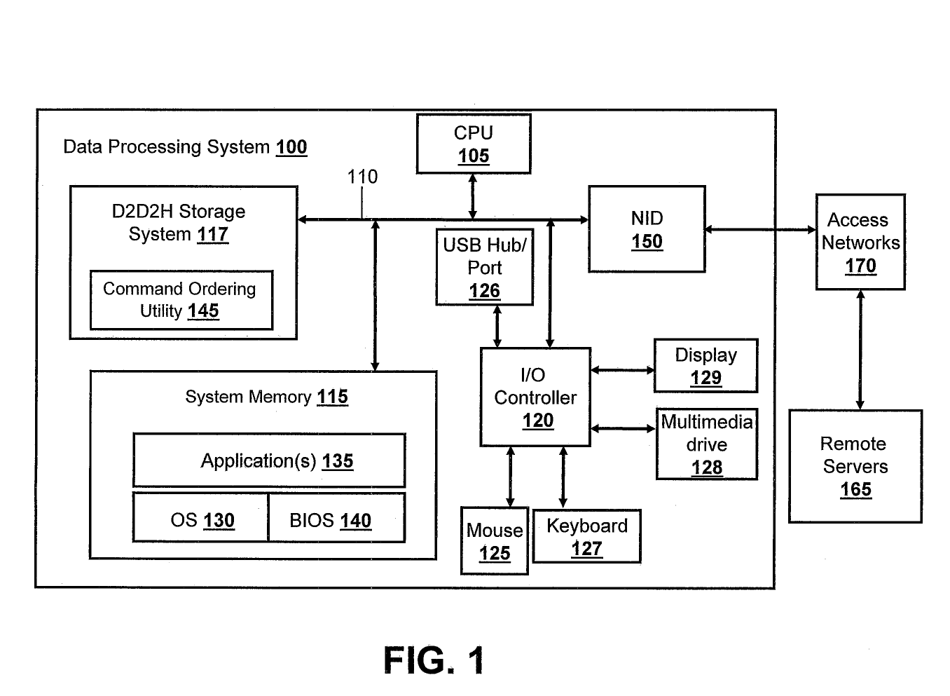

With reference now to FIG. 1, depicted is a block diagram representation of data processing system (DPS) 100 within which features of the invention are implemented. DPS 100 comprises at least one processor or central processing unit (CPU) 105 connected to system memory 115 via system interconnect/bus 110. Also connected to system bus 110 is I/O controller 120, which provides connectivity and control for input devices, of which pointing device (or mouse) 125 and keyboard 127 are illustrated, and output devices, of which display 129 is illustrated. Additionally, multimedia drive 128 (e.g., CDRW or DVDRW drive) and Universal Serial Bus (USB) hub/port 126 are illustrated, coupled to I/O controller 120. Multimedia drive 128 and USB hub/port 126 may operate as both input and output mechanisms for inserting removable storage devices therein. DPS 100 also comprises D2D2H storage system 117, within which data/instructions/code may be stored. DPS 100 is also illustrated with network interface device (NID) 150 coupled to system bus 110. NID 150 enables DPS 100 to connect to one or more remote servers 165 via access networks 170, such as the Internet.

In the described embodiments, when access network 170 is the Internet, access network 170 represents a worldwide collection of networks and gateways that utilize the Transmission Control Protocol/Internet Protocol (TCP/IP) suite of protocols to communicate with one another. Of course, network access may also be provided via a number of different types of networks, such as an intranet, an Ethernet, a Local Area Network (LAN), a Virtual Private Network (VPN), or other Wide Area Network (WAN) other than the Internet, for example.

Notably, in addition to the above described hardware components of DPS 100, various features of the invention are completed via software (or firmware) code or logic stored within system memory 115, in other storage (e.g., D2D2H storage system 117), or stored remotely in memory of server 165 and executed by CPU 105. System memory 115 is defined as a lowest level of volatile memory (not shown), including, but not limited to, cache memory, registers, and buffers. The data/instructions/code are stored in D2D2H storage system 117 and executed by a local processor (not shown) in D2D2H storage system 117. In one embodiment, data/instructions/code stored in remote memory of remote server 165 populates the system memory 115. In another embodiment, the data/instructions/code are stored and executed remotely from remote server 165 and accessed by DPS 100 via NID 150.

Thus, illustrated within system memory 115 are a number of software/firmware components, including operating system (OS) 130 (e.g., Microsoft Windows®, a trademark of Microsoft Corp; or GNU®/Linux®, registered trademarks of the Free Software Foundation and Linus Torvalds; or Advanced Interactive eXecutive -AIX®-, registered trademark of International Business Machines—IBM), applications 135, and Basic Input/Output System (BIOS) 140. Illustrated within D2D2H Storage System 117 is Command Ordering utility 145. For simplicity, Command Ordering utility 145 is illustrated and described as a stand alone or separate software/firmware component, which is stored in D2D2H Storage System 117 to provide/support the specific novel functions described herein. Nevertheless, it should be appreciated that Command Ordering utility 145 can be stored outside of D2D2H Storage System 117, according to another embodiment.

CPU 105 executes Command Ordering utility 145 as well as OS 130, which supports the user interface features of Command Ordering utility 145. In the illustrative embodiment, Command Ordering utility 145 facilitates ordering of commands within D2D2H Storage System 117. Among the software code/instructions provided by Command Ordering utility 145, and which are specific to the invention, are code for: (a) detecting a command from a host system; (b) identifying a hologram segment associated with the detected command; (c) determining whether the hologram segment associated with the detected command is one of an open hologram segment and a closed hologram segment; (d) responsive to a determination that the hologram segment associated with the detected command is a closed hologram segment, determining whether to prioritize the detected command; (e) responsive to a determination that the detected command is to be prioritized, adding the detected command to a prioritized command queue; (f) responsive to a determination that the detected command is not to be prioritized, adding the detected command to a normal command queue; (g) grouping a plurality of detected commands from at least the prioritized command queue and the normal command queue, whereby the grouped commands address the same hologram segment; (h) deferring an execution of at least one of a prioritized command and a normal command for a predetermined time; and (i) after the predetermined time of deferring the grouped commands has elapsed, executing the detected command(s) in sequence based on the command queue and the number of other commands in the command queue.

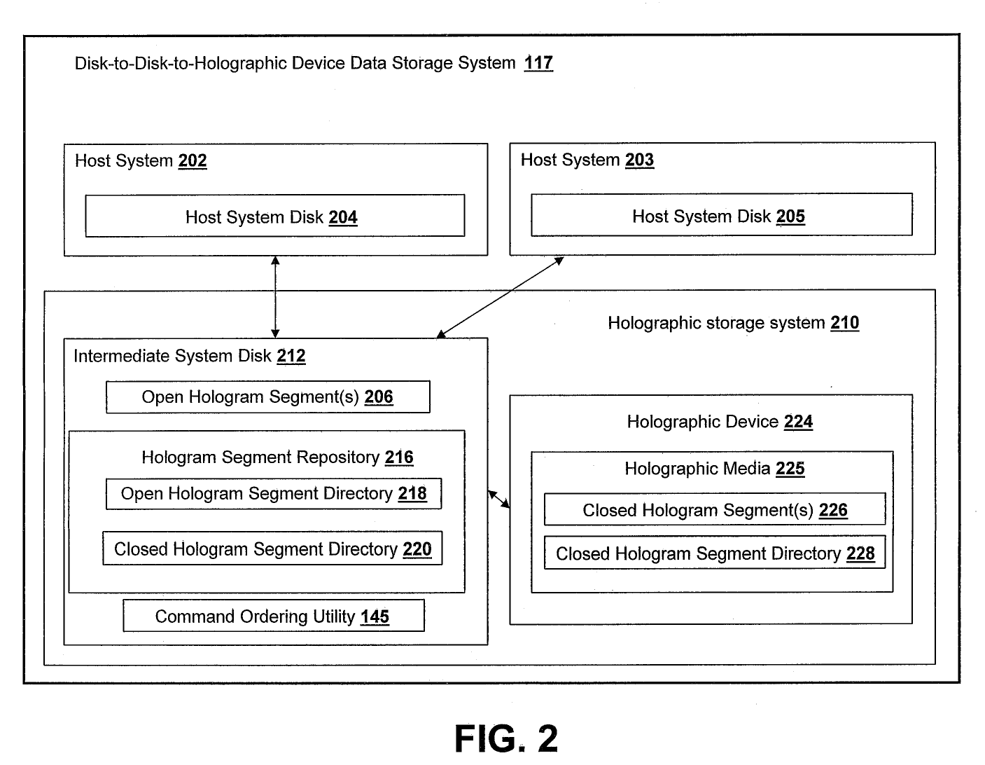

For simplicity of the description, the collective body of code that enables these various features is referred to herein as Command Ordering utility 145. According to the illustrative embodiment, when CPU 105 executes Command Ordering utility 145, DPS 100 initiates a series of functional processes that enable the above functional features as well as additional features/functionality, which are described below within the description of FIGS. 2-5.

Those of ordinary skill in the art will appreciate that the hardware and basic configuration depicted in FIG. 1 may vary. For example, other devices/components may be used in addition to or in place of the hardware depicted. The depicted example is not meant to imply architectural limitations with respect to the present invention. The data processing system depicted in FIG. 1 may be, for example, an IBM System p5™ (a trademark of International Business Machines—IBM), a product of International Business Machines Corporation in Armonk, N.Y., running the AIX® operating system or LINUX® operating system.

Within the descriptions of the figures, similar elements are provided similar names and reference numerals as those of the previous figure(s). Where a later figure utilizes the element in a different context or with different functionality, the element is provided a different leading numeral representative of the figure number (e.g., 1xx for FIGS. 1 and 2xx for FIG. 2). The specific numerals assigned to the elements are provided solely to aid in the description and not meant to imply any limitations (structural or functional) on the invention.

With reference now to FIG. 2, there is depicted an exemplary host-Disk-to-intermediate-Disk-to-Holographic (D2D2H) data storage system 117. System 117 includes host systems 202, 203, which read and write data to holographic storage system 210 using a read command and a write command, respectively. As shown, there can be more than one host system 202, 203 connected to holographic storage system 210. The read and write commands can include, but are not limited to: Small Computer System Interface (SCSI) commands, Internet SCSI (iSCSI) commands, Global-built Environmental Network (GbEN) commands, or any other operation that reads and writes data from host system(s) 202, 203 to holographic storage system 210. Host systems 202, 203 respectively employ host system disks 204 and 205 to store data (i) before the data is written to and/or (ii) after the data is read from intermediate system disk 212. Intermediate system disk 212 is associated with holographic storage system 210. Host system disks 204, 205 and intermediate system disk 212 can include, but are not limited to (a) semiconductor memory, or (b) DVD, HD-DVD, Blu-Ray, phase-change, or magneto-optical disks. Holographic storage system 210 also includes holographic device 224, which is used to read and write data to holographic media 225.

When data is written from host system 202, 203 to holographic storage system 210, the data is initially stored in open hologram segment(s) 206 residing on and maintained by intermediate system disk 212. Open hologram segment(s) 206 is an area of non-volatile memory with equal or greater data storage capacity than closed hologram segment(s) 226 stored on holographic media 225. Intermediate system disk 212 includes hologram segment repository 216, which stores and maintains one or more open hologram segment directories 218. Each open hologram segment directory 218 records a reference to the data stored in corresponding open hologram segment 206. The references to the data can include a block address or a file name.

Hologram segments, which include open hologram segment(s) 206 and closed hologram segment(s) 226, can have one of two storage states: open or closed. Open hologram segment 206 resides in intermediate system disk 212 and the data contained in open hologram segment 206 is accessible by host system(s) 202, 203. When open hologram segment 206 reaches data storage capacity, open hologram segment 206 may be migrated to holographic media 225 as closed hologram segment 226. As a result, open hologram segment 206 may be removed from intermediate system disk 212, and the data stored in closed hologram segment 226 is not accessible on intermediate system disk 212. Alternatively, open holographic segment(s) 206 may be left open when it reaches storage capacity if further updates are expected or it is anticipated that open hologram segment(s) 206 will be accessed for reading. If open hologram segment(s) 206 is anticipated to be read, open hologram segment(s) 206 will be migrated later either due to inactivity in order to free space on intermediate system disk 212 or by an explicit command from host system 202, 203 to close open hologram segment 206.

In addition, when open hologram segment 206 is migrated to holographic media 225, open hologram segment directory 218 is copied to holographic media 225 as closed hologram segment directory 228. Closed hologram segment directory 228 references the data stored in corresponding closed hologram segment 226. In addition to the closed hologram segment directory 228 residing on holographic media 225, a copy of closed hologram segment directory 228 remains in intermediate system disk 212 as closed hologram segment directory 220. Open hologram segment directory 218 and closed hologram segment directory 220 reside in hologram segment repository 216, such that hologram segment repository 216 serves as a central catalog for both open hologram segment(s) 206 and closed hologram segment(s) 226. Usage of hologram segment repository 216 as a single source is advantageous when more than one host system disk 204, 205 is connected to intermediate system disk 212.

Open hologram segment(s) 206 and open hologram segment directory 218 are respectively identical in data content to closed hologram segment(s) 226 and closed hologram segment directory 228 stored on holographic media 225. As long as no write commands are received from host system(s) 202, 203 to closed hologram segment 226, closed hologram segment 226 is maintained in a closed state and will not be opened (i.e., migrate back to intermediate system disk 212 as open hologram segment 206). However, if a write command is received from host system 202, 203 that modifies the contents of closed hologram segment 226, then closed hologram segment 226 is opened. When closed hologram segment 226 is opened, corresponding closed hologram segment directory 228 migrates to intermediate system disk as open hologram segment directory 218.

When host system 202, 203 reads from holographic storage system 210, host system 202, 203 sends a read command that includes a reference to the data to be read from holographic storage system 210. Based on the reference to the data to be read, holographic storage system 210 determines whether the data to be read resides in open hologram segment 206 of intermediate system disk 212, or in closed hologram segment(s) 226 of holographic media 225. For open hologram segment 206, holographic storage system 210 utilizes the reference data stored in hologram segment repository 216. For closed hologram segment 226, holographic storage system 210 utilizes the closed hologram segment directory 220 stored in hologram segment repository 216.

If the data to be read resides in open hologram segment 206, holographic storage system 210 returns the requested read data to host system 202, 203. Otherwise, if the requested read data resides in closed hologram segment 226, holographic storage system 210 accesses holographic media 225 via holographic device 224 and reads the data of closed hologram segment 226 to intermediate system disk 212. In this regard, holographic device 224 supports the option of reading the entire portion of closed hologram segment 226, or reading select portions of closed hologram segment 226. When reading closed hologram segment 226 from holographic media 225 to intermediate system disk 212, the state of closed hologram segment 226 is changed to open and the data contents of closed hologram segment 226 are copied to open hologram segment 206. Alternatively, when the read data is read through intermediate system disk 212 without being stored on intermediate system disk 212, the closed state of closed hologram segment(s) 226 is unchanged. Moreover, open hologram segment directory 218 can be stored in a database structure (not shown) to enable faster queries on intermediate system disk 212.

A plurality of host systems 202, 204 can be employed in reading from or writing to holographic storage system 210. In this regard, host systems 202 and 204 can share the same open holographic segment 206 for reading/writing commands. Alternatively, each host system 202, 204 of a multiple host system can have a separate open holographic segment 206 residing in intermediate system disk 212. Moreover, multiple concurrent read and write commands may be sent by host systems 202, 204 to holographic storage system 210 for one or more open hologram segments 206 and/or closed hologram segment(s) 226. Closed hologram segment(s) 226 reside on holographic media 225. In the case of multiple host systems 202, 204, command ordering utility 145 resides in intermediate system disk 212 since all host systems 202, 204 communicate with intermediate system disk 212. DPS 100 is a platform from which command ordering utility 145 is executed.

Command ordering for reading data from and writing data to holographic storage system 210 is based on several policies. First, read and write commands to and from open hologram segments 206 are queued immediately and executed based upon the queuing priority. Second, read commands to the same “open” hologram segment 206 or to the same “closed” hologram segment 226 can be logically grouped such that the physical read operation satisfies the plurality of read commands to the same hologram segment. However, the read commands, when received within a predefined period, can be logically grouped as long as there are no intervening write commands to the same hologram segment to which the plurality of read commands are to be logically grouped. If intervening write command(s) are present and are to be executed in “normal” queuing priority to the same hologram segment as the plurality of read commands, then the execution order between the read commands and the intervening write commands is maintained (i.e., the plurality of read commands cannot be logically grouped). This second policy preserves data integrity by ensuring that any read command of “normal” queuing priority that is ordered before a write command of “normal” queuing priority to the same hologram segment will be executed before the write command. Similarly, any read command of “normal” queuing priority that is ordered after a write command of “normal” queuing priority to the same hologram segment will be executed after the write command.

A third policy that is followed in command ordering utility 145 is that read and write commands to adjacent open hologram segments 206 and/or to adjacent closed hologram segments 226 on the same holographic media 225 may be grouped sequentially such that the physical read or write operations are most efficiently executed. This third policy is valid as long as: (i) the read and write commands are received within a predefined time period, (ii) the read and write commands have “normal” queuing priority, and (iii) the second policy (discussed earlier) is not violated.

According to one embodiment, read/write commands addressing the same hologram segment are grouped. As a result, the timely order of the commands is maintained. Based on the policies discussed above, read/write commands pertaining to one group (i.e., the read/write commands reference the same hologram segment) represent one command queue entry. The command queue is usually processed in a First-In-First-Out (FIFO) manner. There are additional means to promote command processing from the command queue for data pertaining to certain “closed” hologram segments. The promotion of commands can be user-configurable or set by host system 202, 203. Promotion of commands within the command queue is based on one or more factors including: (i) the hologram segment ID, (ii) the holographic medium in which the hologram segment resides on, (iii) the priority of a host system reading and writing, and (iv) the time period for command queuing. The promotion of commands or command groups indicates that the commands or command groups are added to the prioritized command queue.

With regard to hologram segment ID, this factor considers whether the hologram segment is a hot-designated hologram segment versus a cold-designated hologram segment. As used herein, a hot-designated hologram segment is a hologram segment that is utilized with higher frequency as compared to a cold-designated hologram segment. Moreover, the type of holographic medium that the hologram segment resides on is another factor that is considered. For example, if the holographic medium forms part of a tertiary storage device and the holographic medium is currently mounted in a holographic drive, it would be more efficient if the read/write commands that utilize the currently mounted holographic medium are executed before switching to another holographic medium. With regard to the priority of a host system 202, 203, there may be instances in which the read/write commands directed by a particular host system take precedence over the read/write commands of another host system. The host system includes a host system identification (ID), such as an internet protocol (IP) address or a World Wide Node Name (WWNN). Regarding the time period for command queuing, when a command or set of commands is promoted, this factor considers whether: (a) the promoted command(s) have been queued for an aggregate period of time (i.e., total queue time for all pending commands) and (b) the aggregate period exceeds a user-defined threshold time value.

Under command ordering utility 145, commands and command groups acting upon promoted hologram segments are executed before commands and command groups acting upon non-promoted hologram segments. Thus, there are two command queues: (i) a command queue for promoted commands (i.e., a prioritized queue), and (ii) a command queue for normal, non-promoted commands (i.e., a normal queue). Commands pertaining to the normal command queue are executed in a deferred way in order to: (a) enable the accumulation of commands for more efficient data access and (b) favor the execution of promoted (i.e., prioritized) commands and prioritized command groups. Thus, command execution for normal commands is based on timely thresholds. In addition, if promoted read commands are executed prior to normal write commands addressing the same hologram segment, there is a method for notifying the application in host system 202, 203 that issued the read command. The notification after the execution of the read command indicates to host system 202, 203 that there is more current data that is available for access as a result of a subsequent write command pertaining to the normal command queue.

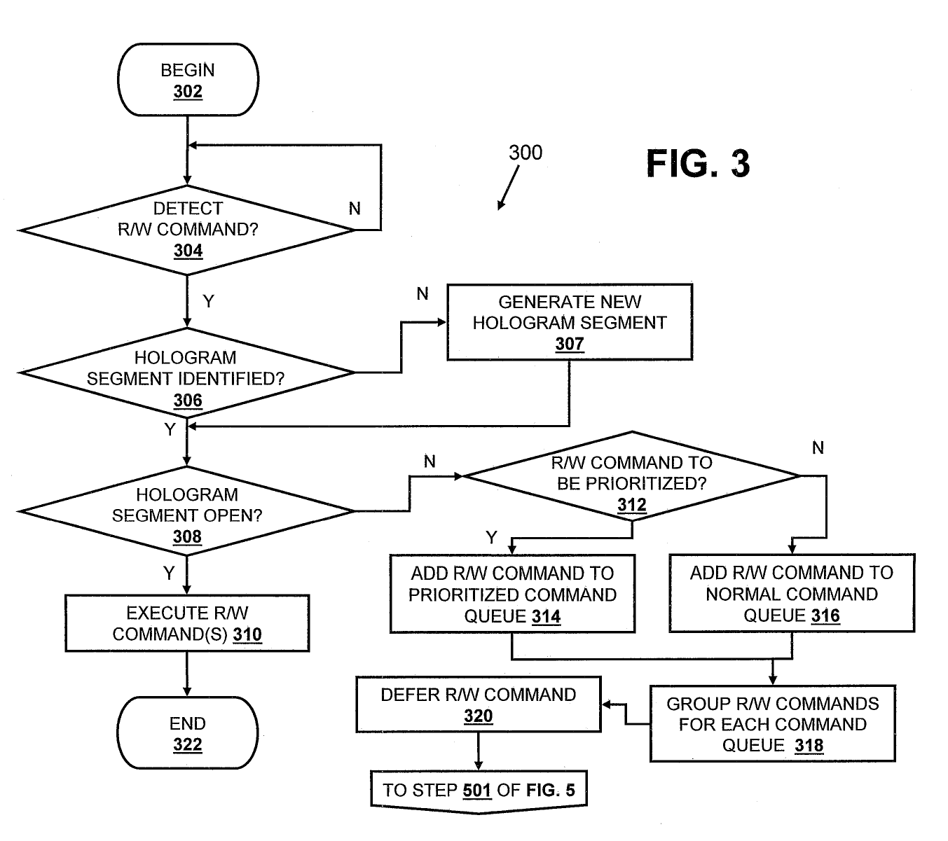

With general reference to FIGS. 3-5, exemplary method steps of command ordering utility 145 (FIGS. 1 and 2) are shown. Referring now to FIG. 3, a flow chart of the command ordering method 300 is illustrated. Method 300 starts in block 302 and continues to decision block 304 in which a determination is made whether command ordering utility 145 has detected a read or write (R/W) command from host system 202, 203 (FIG. 2). If a R/W command is not detected, method 300 continues in decision block 304 until a R/W command is detected. The R/W command includes a data reference to the data that is stored in either open hologram segment 206 (FIG. 2) or closed hologram segment 226 (FIG. 2). If a R/W command is detected, a determination is then made whether the associated hologram segment 206, 226 is identified in block 306. The associated hologram segment is identified based on the: (i) input data from host system 202, 203, (ii) hologram segment addressed by the R/W command, and (iii) holographic medium 225 (FIG. 2) that stores closed hologram segment addressed by the R/W command.

If no hologram segment is identified in decision block 306, then the R/W command will generate a new open hologram segment, as depicted in block 307. Once a new hologram segment has been generated or a hologram segment has been identified, method 300 continues to decision block 308. At decision block 308, a determination is made whether the identified hologram segment is open and thus accessible to a R/W command. In this regard, newly opened hologram segments are already open. If the answer to decision block 308 is “Yes”, method 300 continues to block 310 where the command is executed. From block 310, method 300 continues to termination block 322.

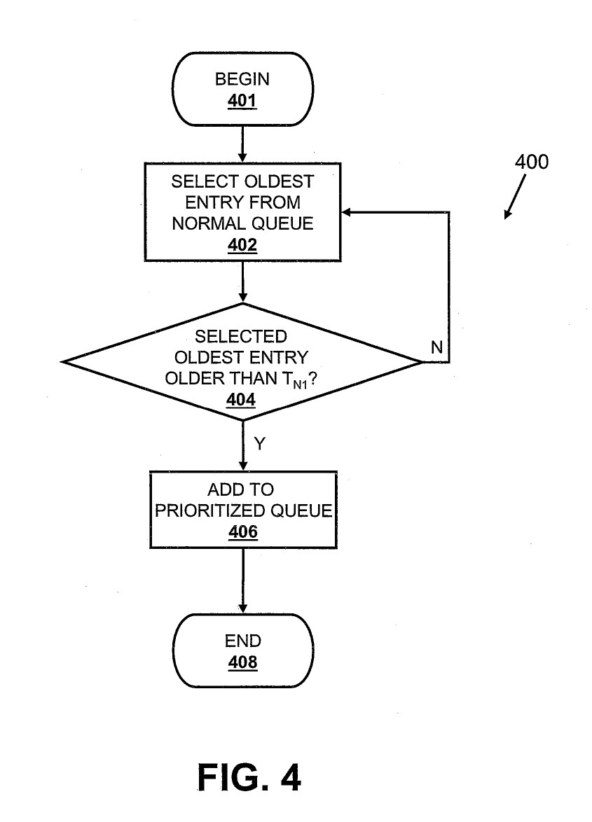

If the identified hologram segment is closed (i.e., not accessible by R/W command), method 300 continues from block 308 to decision block 312 where a determination is made whether the normal R/W command is to be promoted (i.e., prioritized). This decision might be based on a) input from host system (i.e., hologram segment ID), b) the hologram segment addressed by the R/W command, or c) the holographic medium that stores the hologram segment addressed by the R/W command. If the R/W command is to be prioritized, the R/W command is added to the prioritized command queue, as depicted in block 314. Further discussion regarding how a R/W command is prioritized (i.e., promoted from a normal command queue) is discussed below with reference to FIG. 4. Otherwise, if the R/W command is not prioritized, the command is added to the normal command queue in block 316. In either blocks 314 or 316, the timely sequence of commands addressing the same closed hologram segment is maintained.

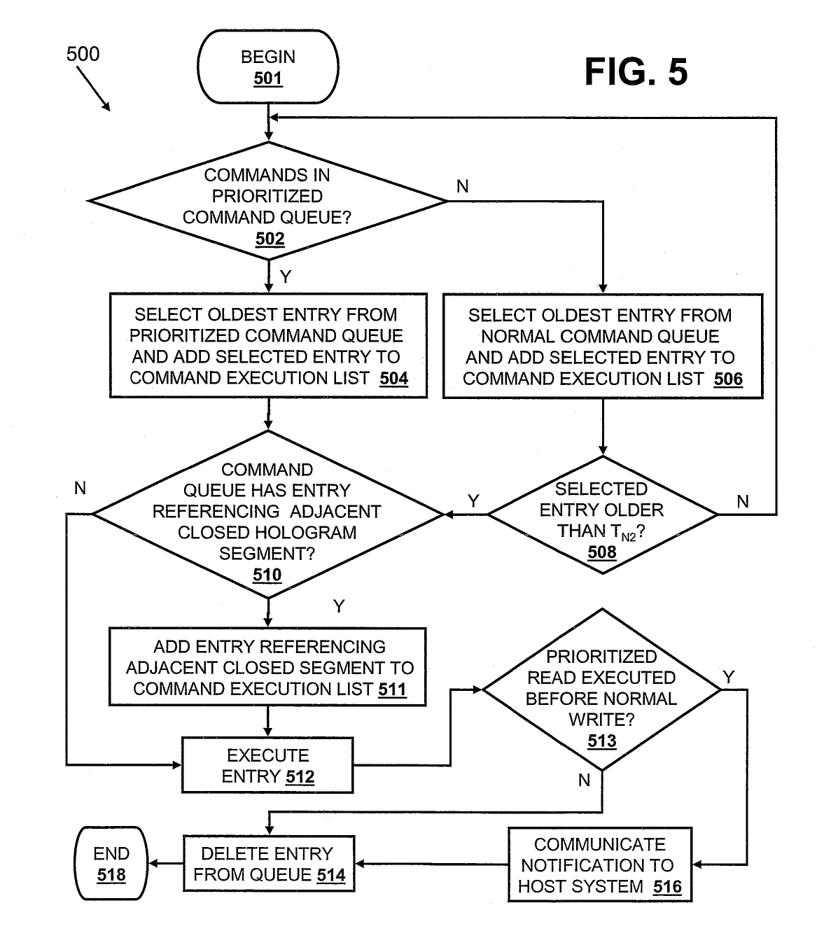

From blocks 314 and 316, method 300 flows to block 318 where the R/W commands for each command queue are grouped. In this regard, prioritized and normal commands addressing the same hologram segment are grouped into one command group per hologram segment. From block 318, method 300 continues to block 320 where the execution of R/W command is deferred. Command execution can be deferred in block 320 by protocol-specific communication between host system(s) 202, 203 and holographic storage system 210. In one example, the Small Computer System Interface (SCSI) protocol can provide a method to disconnect communication with host system(s) 202, 203. From block 320, method 300 continues to block 501 of FIG. 5, which describes the execution of commands that reference closed command segment(s).

In summary, method 300 of FIG. 3 outlines three distinct treatments of R/W commands. According to the first treatment, a R/W command to open hologram segment(s) 206 is executed immediately. In the second treatment, a R/W command to closed hologram segment(s) 226, which is/are promoted based on promotion policies discussed above, is queued in a prioritized (or promoted) command queue. In the third treatment, a R/W command to closed hologram segment(s) 226, which is/are not promoted, is queued in a normal command queue. Additional description of the execution of deferred R/W commands in the prioritized and/or normal queue is discussed with reference to FIG. 5.

When commands are added in the normal and/or priority queue, as shown in blocks 314 and 316, the commands are being grouped with other commands that reference the same closed hologram segment 226. All commands referencing the same closed hologram segment 226 are grouped and represented as a single command queue entry. In addition, a time stamp indicating when the command was detected in decision block 304 is added to the command queue for each command or command group. Among the commands pertaining to the same closed hologram segment 226, the time stamp of the oldest command is representative of the particular command group. Adding a time stamp to a command queue entry (i.e., commands or command groups) facilitates the identification of the oldest command in the queue, as well as the identification of the total aggregate time for all commands in a command group. In addition, the time stamp allows for the deferred execution of a command for a predetermined period of time in order to determine whether additional commands are to be received for that same command group.

The total aggregate time for a command group is an important factor in the promotion of certain commands or command groups as this factor distinguishes between command groups on the basis of performance. For example, if a first command group has a higher aggregate queue time than a second command group, then the first command group would have a higher priority than the second command group. This method of command execution based on the aggregate time stamp within a command or command group is discussed further in FIG. 5 below.

With reference now to FIG. 4, method 400 for promoting (i.e., prioritizing) normal commands is shown. Method 400 ensures that commands in a normal command queue are promoted if the commands have a time stamp that is older than a first time threshold value T_{N1} that is predetermined. Moreover, method 400 runs continuously in the background and monitors the normal command queue(s) for such time stamp data. Method 400 begins at block 401 and continues to block 402. At block 402, an entry (command or command group) having the oldest time stamp is selected from the normal command queue. Once the oldest entry has been selected, a determination is made whether the selected oldest entry is older than the predetermined first threshold time value T_{N1}, as depicted in block 404. If the selected oldest entry in the normal command queue is older than the predetermined first threshold time value, then method 400 continues to block 406 where the selected entry is added to the prioritized queue. Otherwise, if the selected oldest entry in the normal command queue is not older than the predetermined first threshold time value T_{N1}, then method 400 returns to the block 402. After block 406, method 400 terminates at block 408.

Referring now to FIG. 5, method 500 for executing a command or command group based on the aggregate time stamp within the prioritized queue or normal queue is shown. Method 500 begins at block 501 and continues to decision block 502, in which a determination is made whether there are any commands (i.e., R/W commands) in a prioritized command queue. If there are commands in the prioritized command queue, the oldest entry (i.e., command or command group) from prioritized command queue is selected and added to a command execution list, as depicted in block 504. If there are no commands in the prioritized command queue, the oldest entry from normal command queue is selected and added to the command execution list, as depicted in block 506.

From block 506, method 500 continues to decision block 508 in which a determination is made whether the selected oldest entry is associated with a time stamp that is older than a second threshold time value T_{N2} that is configurable. T_{N2} time value specifies a maximum time threshold for which commands in the normal command queue are deferred (i.e., held) before the commands in the normal command queue are executed in sequence. If the selected oldest entry from the normal command queue is not older than the second threshold time value T_{N2}, method 500 returns to decision block 502. Deferring normal commands enables (a) prioritized commands to be executed, and (b) the accumulation of normal commands for the same hologram segment over the second threshold time value (T_{N2}). The maximum time (i.e., second threshold time value T_{N2}) a command is held/deferred before execution is configured to be less than the first threshold time value T_{N1} (FIG. 4) for read and/or write commands between host system(s) 202, 203 (FIG. 2) and holographic storage system 210 (FIG. 2). This configuration of time thresholds ensures that a normal command is being promoted (i.e., added prioritized command queue) at least after the first threshold time value T_{N1}, and executed after the second threshold time value T_{N2}. Moreover, by returning normal commands to decision block 502, prioritized commands can be executed despite normal commands having not reached a particular timeout. However, if (i) the selected oldest entry from the normal command queue is older than the second threshold time value T_{N2}, or (ii) the oldest entry from the prioritized command queue is selected, method 500 continues to decision block 510.

At decision block 510, a determination is made whether the command queue includes an entry (i.e., command(s) and/or command group(s)) that references an adjacent closed hologram segment residing on the same holographic medium 225. If there is no entry that references an adjacent hologram segment, the entry in command execution list is executed, as depicted in block 512. However, if there is an entry that references an adjacent closed hologram segment residing on the same holographic medium 225, the entry referencing the adjacent closed hologram segment is added to the command execution list (block 511) and then executed along with any other command queue entries in the command execution list (block 512).

Once the entry has been executed, method 500 continues to decision block 513, where a determination is made whether a prioritized read command has been executed prior to a normal write command that references the same hologram segment. If a prioritized read is executed before a normal write command and the commands reference the same hologram segment, command ordering utility 145 (FIGS. 1 and 2) communicates a notification (block 516) to host system(s) 202, 203, which issued the read command. The notification alerts the host system(s) 202, 203 that a normal write command will be executed after the prioritized read command. As such, the subsequent write command may contain more current data than what was retrieved pursuant to the previous prioritized read command. However, if either (i) the prioritized read command is not executed before a normal write command, or (ii) the notification has been communicated to host system 202, 203, the executed entry is removed (i.e., deleted) from the command queue and the command execution list (block 514). Method 500 ends at termination block 518.

In the flow charts (FIGS. 3-5) above, one or more of the methods are embodied as a computer program product in a computer readable medium or containing computer readable code such that a series of steps are performed when the computer readable code is executed on a computing device. In some implementations, certain steps of the methods are combined, performed simultaneously or in a different order, or perhaps omitted, without deviating from the spirit and scope of the invention. Thus, while the exemplary method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

As will be further appreciated, the exemplary method steps in embodiments of the present invention may be implemented using any combination of software, firmware or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, etc., thereby making an article of manufacture (or computer program product) in accordance with the invention. The article of manufacture containing the programming code is used by either executing the code directly from the storage device, by copying the code from the storage device to another storage device such as a hard disk, RAM, etc., or by transmitting the code for remote execution using transmission type media such as digital and analog communication links. The methods of the invention may be practiced by combining one or more machine-readable storage devices containing the code according to the present invention with appropriate processing hardware to execute the code contained therein. An apparatus for practicing the invention could be one or more processing devices and storage systems containing or having network access to program(s) coded in accordance with the invention.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a computer program product in a variety of forms, and that an illustrative embodiment of the present invention applies equally regardless of the particular type of media used to actually carry out the distribution. By way of example, a non exclusive list of types of media includes recordable type (tangible) media such as floppy disks, thumb drives, hard disk drives, CD ROMs, DVDs, and transmission type media such as digital and analogue communication links.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teaching of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. In a computing device, a method for command ordering for a host-Disk-to-intermediate-Disk-to-Holographic (D2D2H) data storage system comprising:
detecting a command from a host system;
identifying a hologram segment associated with the detected command;
determining whether the hologram segment associated with the detected command is one of an open hologram segment and a closed hologram segment;
responsive to a determination that the hologram segment associated with the detected command is a closed hologram segment, determining whether to prioritize the detected command;
responsive to a determination that the detected command is to be prioritized, adding the detected command to a prioritized command queue;
responsive to a determination that the detected command is not to be prioritized, adding the detected command to a normal command queue;
grouping a plurality of detected commands from at least said prioritized command queue and said normal command queue, wherein said plurality of detected commands address the same hologram segment;
deferring an execution of at least one of a prioritized command and a normal command for a predetermined time; and
responsive to said deferring step, executing each one of the plurality of detected commands in sequence;
wherein the detected command is one of a read command and a write command.

2. The method of claim 1, further comprising:
selecting an oldest entry to be prioritized from the normal command queue;
determining whether a time stamp associated with the selected oldest entry is older than a first time threshold value; and
responsive to the determination that the time stamp associated with the selected oldest entry is older than the first time threshold value, adding the selected oldest entry to the prioritized command queue.

3. The method of claim 2, further comprising:
determining whether there is at least one command in the prioritized command queue;
responsive to the determination that there is at least one command in the prioritized command queue, selecting the oldest entry from the prioritized command queue;
responsive to the determination that there is at least one command in the normal command queue, selecting the oldest entry from the normal command queue and determining whether a time stamp of the selected oldest entry from the normal command queue is older than a second time threshold value; and
adding the selected oldest entry to a command execution list.

4. The method of claim 3, further comprising:
determining whether a command queue from a group that includes the prioritized command queue and the normal command queue includes an entry that references an adjacent hologram segment;
responsive to the determination that the command queue includes the entry that references the adjacent hologram segment, adding the entry that references the adjacent segment to the command execution list; and
executing the entry that references the adjacent segment to the command execution list.

5. The method of claim 4, further comprising:
determining whether the executed entry is a prioritized read command that precedes an execution of a normal write command; and
responsive to the determination that the prioritized read command precedes the execution of the normal write command, communicating a notification to the host system.

6. A computer program product comprising:
a computer storage medium; and
program code on the computer storage medium that when executed provides the functions of:
detecting a command from a host system;
identifying a hologram segment associated with the detected command;
determining whether the hologram segment associated with the detected command is one of an open hologram segment and a closed hologram segment;
responsive to a determination that the hologram segment associated with the detected command is a closed hologram segment, determining whether to prioritize the detected command;
responsive to a determination that the detected command is to be prioritized, adding the detected command to a prioritized command queue;
responsive to a determination that the detected command is not to be prioritized, adding the detected command to a normal command queue;
grouping a plurality of detected commands from at least said prioritized command queue and said normal command queue, wherein said plurality of detected commands address the same hologram segment;
deferring an execution of at least one of a prioritized command and a normal command for a predetermined time; and
responsive to said deferring step, executing each one of the plurality of detected commands in sequence;
wherein the detected command is one of a read command and a write command.

7. The computer program product of claim 6, the program code further provides the functions of:
selecting an oldest entry to be prioritized from the normal command queue;
determining whether a time stamp associated with the selected oldest entry is older than a first time threshold value; and
responsive to the determination that the time stamp associated with the selected oldest entry is older than the first time threshold value, adding the selected oldest entry to the prioritized command queue.

8. The computer program product of claim 7, the program code further provides the functions of:
determining whether there is at least one command in the prioritized command queue;
responsive to the determination that there is at least one command in the prioritized command queue, selecting the oldest entry from the prioritized command queue;
responsive to the determination that there is at least one command in the normal command queue, selecting the oldest entry from the normal command queue and determining whether a time stamp of the selected oldest entry from the normal command queue is older than a second time threshold value; and
adding the selected oldest entry to a command execution list.

9. The computer program product of claim 8, the program code further provides the functions of:
determining whether a command queue from a group that includes the prioritized command queue and the normal command queue includes an entry that references an adjacent hologram segment;
responsive to the determination that the command queue includes the entry that references the adjacent hologram segment, adding the entry that references the adjacent segment to the command execution list; and
executing the entry that references the adjacent segment to the command execution list.

10. The computer program product of claim 9, the program code further provides the functions of:
determining whether the executed entry is a prioritized read command that precedes an execution of a normal write command; and
responsive to the determination that the prioritized read command precedes the execution of the normal write command, communicating a notification to the host system.

11. A data processing system comprising:
a processor;
a host-Disk-to-intermediate-Disk-to-Holographic (D2D2H) data storage system coupled to said processor:
a command ordering utility executing on the processor and having executable code for:
detecting a command from a host system;
identifying a hologram segment associated with the detected command;
determining whether the hologram segment associated with the detected command is one of an open hologram segment and a closed hologram segment;
responsive to a determination that the hologram segment associated with the detected command is a closed hologram segment, determining whether to prioritize the detected command;
responsive to a determination that the detected command is to be prioritized, adding the detected command to a prioritized command queue;
responsive to a determination that the detected command is not to be prioritized, adding the detected command to a normal command queue;
grouping a plurality of detected commands from at least said prioritized command queue and said normal command queue, wherein said plurality of detected commands address the same hologram segment;
deferring an execution of at least one of a prioritized command and a normal command for a predetermined time; and
responsive to said deferring step, executing each one of the plurality of detected commands in sequence;
wherein the detected command is one of a read command and a write command.

12. The data processing system of claim 11, the command ordering utility further having executable code for:
selecting an oldest entry to be prioritized from the normal command queue;
determining whether a time stamp associated with the selected oldest entry is older than a first time threshold value; and
responsive to the determination that the time stamp associated with the selected oldest entry is older than the first time threshold value, adding the selected oldest entry to the prioritized command queue.

13. The data processing system of claim 12, the command ordering utility further having executable code for:
determining whether there is at least one command in the prioritized command queue;
responsive to the determination that there is at least one command in the prioritized command queue, selecting the oldest entry from the prioritized command queue;
responsive to the determination that there is at least one command in the normal command queue, selecting the oldest entry from the normal command queue and determining whether a time stamp of the selected oldest entry from the normal command queue is older than a second time threshold value; and
adding the selected oldest entry to a command execution list.

14. The data processing system of claim 13, the command ordering utility further having executable code for:
determining whether a command queue from a group that includes the prioritized command queue and the normal command queue includes an entry that references an adjacent hologram segment;
responsive to the determination that the command queue includes the entry that references the adjacent hologram segment, adding the entry that references the adjacent segment to the command execution list; and
executing the entry that references the adjacent segment to the command execution list.

15. The data processing system of claim 14, the command ordering utility further having executable code for:
determining whether the executed entry is a prioritized read command that precedes an execution of a normal write command; and
responsive to the determination that the prioritized read command precedes the execution of the normal write command, communicating a notification to the host system.
